(19) United States
(12) Patent Application Publication
(10) Pub. No.: US 2011/0231254 A1
(43) Pub. Date: Sep. 22, 2011

(54) METHOD AND SYSTEM FOR PROVIDING ADVERTISEMENTS, AND COMPUTER-READABLE RECORDING MEDIUM

(75) Inventors: Youn Sik Lee, Seoul (KR); Dong Wook Kim, Seongnam-si (KR); Jung Soo Ha, Yongin-si (KR); Yu Won Kim, Seongnam-si (KR)

(73) Assignee: NHN BUSINESS PLATFORM CORPORATION, Seongnam-si (KR)

(21) Appl. No.: 13/062,677

(22) PCT Filed: Sep. 4, 2009
(86) PCT No.: PCT/KR09/05033

§ 371 Date: May 25, 2011

(30) Foreign Application Priority Data
Sep. 5, 2008 (KR) 10-2008-0087970

(51) Int. Cl. G06Q 30/00

(52) U.S. Cl. 705/14.49; 705/14.69

(57) ABSTRACT

The present invention relates to a method that enables an advertiser to show self-billing information when providing an advertising service, a system thereof, and a computer-readable recording medium. According to one aspect of the invention, provided is an advertising method which comprises: a step for providing the advertiser with a result of online advertising, a step for receiving from the advertiser, based on the result of online advertising, the self-billing information for the online advertisements that have been already published, and a step for processing the billing for the published advertisements based on the self-billing information.

### TECHNICAL FIELD

The present invention relates to a method that enables an advertiser to show self-billing information (billing criteria) upon previously provided advertisements by referring to a result of advertisement provided when providing an advertising service, a system thereof, and a computer-readable recording medium, more particularly, to a method that increases a benefit of an advertising service provider and an advertiser by enabling an advertiser to provide self-billing criteria based on information regarding a result of previously provided advertisements, a system thereof, and a computer-readable recording medium.

### TECHNICAL BACKGROUNDS

As achieving information through internet searching is generalized, an online advertisement is being invigorated. The online advertisement is provided in various forms such as search advertisements, banner advertisements, and context advertisements.

A typical online advertisement, a search advertisement, in the event of a user performing a search with a particular keyword using a search engine, is an advertising technique that enables advertisement information (generally including a link toward a landing page) such as an advertiser's web page address, advertising message, advertising image may be published.

In such search advertisement, compared to an offline advertisement, record information regarding providing such advertisement may be aggregated more precisely, and various billing models have been developed based on such advertisements providing record information. In an online advertisement including a search advertisement, there are typical billing models such as CPA (Cost Per Action) method that calculates advertising costs according to a result of behavior of user whom the advertisement is provided, CPC (Cost Per Click) method that calculates advertising costs according to a number of clicks occurred by a user selecting advertisement information, and CPI (Cost Per Impression) method that calculates advertising costs according to a number of advertising display to a user.

Despite the aforesaid development of billing model based on more precise advertisement providing records compared to an offline advertisement (for example, a news paper advertisement), there still exists an uncertainty (a risk) concerning a calculation of expenses from a the point of view of the advertiser. For example, an advertising cost may be calculated based on a number of user clicks in a search advertisement based on CPC model, but an uncertainty exists concerning to consider the extent of a proportion of invalid clicks (fault clicks) from the total clicks observed. Such uncertainty related to invalid clicks is a huge risk not only for an advertiser but also for an advertisement network manager who provides an advertisement. Also, in a common advertising model that applies bidding price entered prior to an advertisement display to both an order arrangement and billing of specific advertisement, an advertiser participates in providing an advertisement based on limited information regarding providing an advertisement in uncertain future.

Thus, when using a search advertisement, it is necessary to develop a technology that enables an advertiser to confirm the effect of advertisement more directly, thereby provide a unit price of advertising freely.

### DETAILED DESCRIPTION OF THE DISCLOSURE

### Technical Purposes

The purpose of the present invention is to resolve a problem of described prior art.

And, also, the additional purpose of the present invention is to enable an advertiser to conform a result of advertising more directly.

And, also, the additional purpose of the present invention is to enable an advertiser to provide billing criteria freely based on a result of advertising that an advertiser confirmed.

And, also, the additional purpose of the present invention is to enable an advertisement service provider, while gaining more confidence from an advertiser, to increase the profitability of advertisement service by applying a more advanced advertising method.

### Technical Resolving Method

A typical composition of the present invention for achieving aforesaid purposes is as followings.

In accordance with one aspect of the present invention, an advertisement providing method comprises: a step for providing information regarding a result of online advertising to an advertiser; a step for receiving self-billing information regarding the previously published aforesaid online advertisement based on the aforesaid result information; and a step for conducting billing on previously published advertisement based on the aforesaid self-billing information.

After the step for conducting billing, it is more preferable for the advertisement providing method in accordance with the present embodiment to additionally include a step for controlling advertising display attribution of an online advertisement related to the aforesaid advertiser by considering the aforesaid self-billing information.

The aforesaid advertisement preferably includes a keyword advertisement through matching a keyword and a keyword specified by the advertiser.

The aforesaid self-billing information is preferably input in terms of units of which the aforesaid advertisement is published.

The aforesaid self-billing information preferably includes information regarding discriminative information, the amount of self-billing, and a publication period of advertisement subjected to payment.

The aforesaid step for conducting preferably includes: a step for calculating the billing estimates based on information regarding the result of the aforesaid advertisement published; a step for setting up a possible range for billing to which the aforesaid calculated billing estimates belong; a step for performing an extra authorizing procedure in the case of which the amount of self-billing, which is input by the aforesaid advertiser, do not belong to the possible range for billing.

The aforesaid step for adjusting advertising display attribution preferably adjusts the priority index regarding a keyword advertisement based on the total amount of billing regarding the result of publishing the aforesaid online advertisement.

The aforesaid priority index is preferable to be the value calculated by dividing the aforesaid total amount of billing by the expected number of clicks (ECC), wherein the expected number of clicks is the value calculated by the multiplication of the expected click expenses (CCR) in accordance with the advertising display and the number of clicks of users regarding the advertisement occurred in previous displays.

The aforesaid information regarding the result of published online advertisement to preferably be aggregated by a clicking behavior on a search result page performed by a large number of users.

The aforesaid step for conducting billing preferably conducts billing regarding advertisement publishing expenses by intactly reflecting self-billing input by the aforesaid advertiser.

The aforesaid step for conducting billing preferably conducts billing regarding advertisement publishing expenses by changing the balance information of the account of the aforesaid advertiser.

The aforesaid step for receiving self-billing information more preferably includes a step for the amount of self-billing being provided again by the aforesaid advertiser in the case of which the amount of self-billing, which is provided upon at least some of the aforesaid plurality of keywords, is less than the estimated amount of billing to a certain extent according to pre-determined proper billing criteria.

The method for providing advertisements in accordance with the present embodiment preferably and additionally includes a step for arranging advertisements by the aforesaid advertising display attribution being the criterion.

In accordance with the present invention, the advertisement providing system comprising a unit for providing information that provides information regarding a result of publishing online advertisement to an advertiser, a unit for processing billing that receives self-billing information regarding the aforesaid previously published online advertisement based on the aforesaid publication result information and includes the unit for processing billing that performs billing upon previously published advertisement based on the aforesaid self-billing information is provided.

The advertisement providing system in accordance with the present invention preferably and additionally includes the unit for controlling display attribution that controls the display attribution of online advertisement related to the aforesaid advertiser. The aforesaid advertisement preferably includes a keyword advertisement through matching a keyword with a keyword determined by an advertiser.

The aforesaid self-billing information is preferably input in terms of units of which the aforesaid advertisement is published.

The aforesaid self-billing information preferably includes information regarding discriminative information, the amount of self-billing, and a publication period of advertisement subjected to payment.

The aforesaid self-billing information preferably includes information regarding discriminative information, the amount of self-billing, and a publication period of advertisement subjected to payment.

The aforesaid unit for processing billing preferably sets up a possible range for billing to which the aforesaid calculated billing estimates belong, and performs an extra authorizing procedure in the case of which the amount of self-billing, which is input by the aforesaid advertiser, do not belong to the possible range for billing.

The aforesaid unit for adjusting advertising display attribution preferably adjusts the priority index regarding a keyword advertisement based on the total amount of billing regarding the result of publishing the aforesaid online advertisement.

The aforesaid priority index is preferable to be the value calculated by dividing the aforesaid total amount of billing by the expected number of clicks (ECC), wherein the expected number of clicks is the value calculated by the multiplication of the expected click expenses (CCR) in accordance with the advertising display and the number of clicks of users regarding the advertisement occurred in previous displays.

The aforesaid information regarding the result of published online advertisement to preferably be aggregated by a clicking behavior on a search result page performed by a large number of users.

The aforesaid unit for processing billing preferably conducts billing regarding advertisement publishing expenses by intactly reflecting self-billing input by the aforesaid advertiser.

The aforesaid unit for processing billing preferably conducts billing regarding advertisement publishing expenses by changing the balance information of the account of the aforesaid advertiser.

The aforesaid unit for processing billing more preferably includes a step for the amount of self-billing being provided again by the aforesaid advertiser in the case of which the amount of self-billing, which is provided upon at least some of the aforesaid plurality of keywords, is less than the estimated amount of billing to a certain extent according to pre-determined proper billing criteria.

The aforesaid unit for controlling display attribution preferably includes a step for arranging advertisements by the aforesaid advertising display attribution being the criterion.

Besides above, a computer-readable recording medium that records a computer program for executing a different method, system, and the aforesaid methods.

### Advantageous Effects

In accordance with the present invention, the advertiser may confirm a result of advertisement published more directly.

In accordance with the present invention, the advertiser may provide billing criteria (self-billing information) based on a result of advertisement published, which is confirmed by the advertiser.

In accordance with the present invention, the advertisement service provider, gaining more confidence from an advertiser, may increase the profitability of advertisement service by applying a more advanced advertising method.

### BRIEF DESCRIPTIONS OF FIGURES

FIG. 1 is a figure that exemplifies an environment in which the method for providing advertisement is embodied in accordance with one embodiment.

FIG. 2 is a figure that illustrates an internal composition of the system for providing advertisement in accordance with one embodiment.

FIG. 3 is a figure that exemplifies a subject participates in a method for providing advertisement in accordance with one embodiment.

FIG. 4 is an illustration that illustrates an interface provided to the advertiser through the advertiser's apparatus in accordance with one embodiment.

FIG. 5 is an operation flow chart to explain a method for providing advertisement of a system for providing advertisement.

FIGS. 6 to 8 are tables that represent respectively calculated priority indexes using the total amount of billing of keywords.

### BEST FORM FOR EMBODYING THE DISCLOSURE

Detailed explanations regarding the present invention below are referring to attached figures illustrating specific embodiments that may be embodied as examples. These embodiments are explained in detail enough so that a person in the pertinent art may embodies the present invention. It should be understood that various embodiments of the present invention are different from each other but don't have to be exclusive. For example, specific forms, structure, and features that are described here may be embodied without deviating from spirit and a range of the present invention. Also, positions or dispositions of individual components in embodiments described respectively may be altered without deviating from spirit and a range of the present invention. Thus, detailed descriptions below are not to limit to defining meanings, and a scope of claims, if they are properly explained, are only defined by the claims attached along with all equivalent scopes and claims. Similar referencing symbols in figures indicate identical or similar functions with all aspects.

Referring to attached figures regarding preferable embodiments of the present invention, in order to enable for a person of ordinary skill in the pertinent art to easily embody the present invention, below explains in detail.

### Preferable Embodiments of the Present Invention

In accordance with the present embodiments, in the case of a user performing a search with a specific keyword (e.g. search keywords, search categories) using a search engine, the search advertisement gives a general name to a web page address of the advertiser on a specific location of a search result page, an advertising message (for many cases, including a web link for aiding a connection to such as a web page of the advertiser that performs a role as an advertisement), and an advertising technique or a advertising method that enables advertisement information to be described. Especially, a search advertisement mentioned in the present embodiment should be understood as the widest meaning that comprehends even a keyword advertisement displaying the aforesaid search keyword and its related advertisements along with a search result provided by a search site according to a search keyword entered by a user.

Also, ‘self-billing information’ in the present embodiment means a billing criterion decided autonomously according to the publication of online advertisement by the advertiser, and units or forms of the input may be variously altered.

Environment in which the Entire System is Embodied

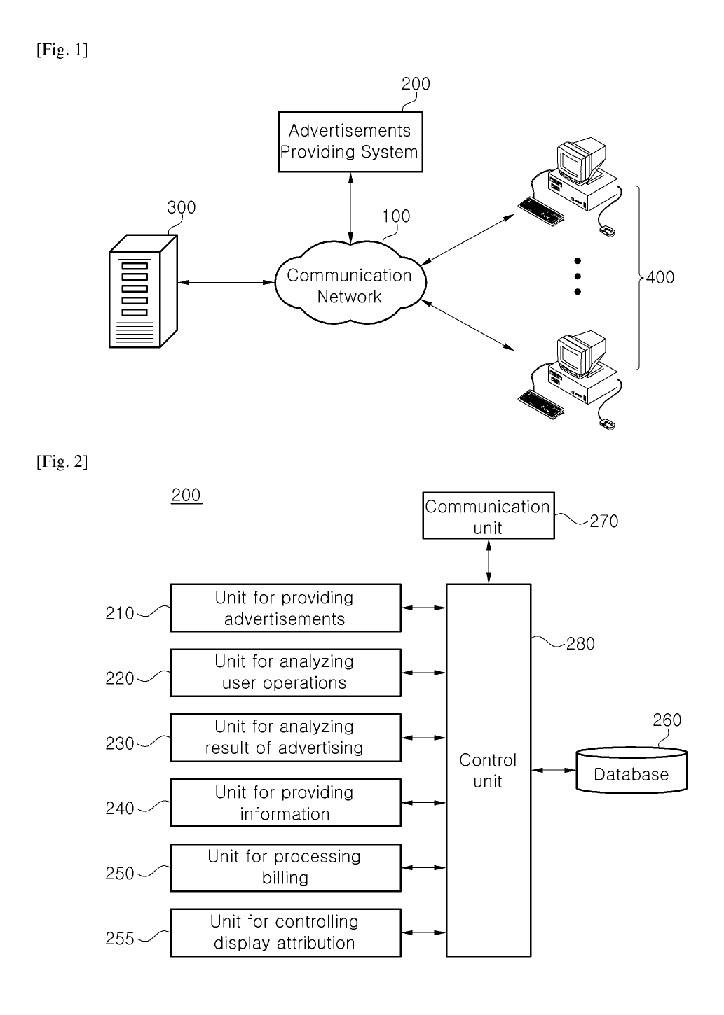

FIG. 1 is a figure that exemplifies an environment in which the method for providing advertisement is embodied in accordance with one embodiment.

As illustrated in FIG. 1, the entire system of the present invention may be comprised including a communication network (100), an advertisements providing system (200), an advertiser's apparatus (300), and a plurality of user apparatus device to which a search advertisement may be provided by inputting a search keyword after connecting to the advertisements providing system (200) through the communication network (100).

The communication network (100) is a network that aids a communication between the system illustrated in FIG. 1 and apparatuses. A composition of a base communication technology comprising the communication network (100) does not fundamentally influence the embodiment of the present invention. The communication network (100) may be comprised regardless of any types such as wires or wireless. The communication network (100) may be comprised based on any type of communication networks that enable informational exchanges between systems and apparatuses. Also, of course, various technologies published for reliability and security of information exchange processes may be applied to the communication network (100).

The advertisements providing system (200) is a system that provides an advertisement through the communication network (100) in accordance with the present invention.

The advertisements providing system (200) may be input information regarding a providing condition of advertisements from the advertiser's apparatus (300).

Prior to providing an advertisement toward the user apparatus (400), the advertiser may be input such as information regarding a keyword concerning the corresponding advertisement, targeting information for user exposed to an advertisement, limitation of advertising display, and a title and description (T&D) of the advertisement that will be provided to a user. Such information may be utilized for a display criterion of an advertisement like in an existing bidding-based search keyword advertisement.

In the method for providing advertisements according to the embodiment of the present invention, an input of a bid amount (BA) upon an advertisement which will be published in the future may not be needed. In accordance with the existing bidding keyword advertisement, the bidding amount of advertiser is utilized for a criterion for calculating a billing amount per click upon determining a displaying order and display advertisement between a plurality of advertisements regarding corresponding keywords. However, in the method for providing advertisements according to the embodiment of the present invention, determining a displaying order and display advertisement may be executed based on ‘self-billing’ that is input after an advertisement being published.

The advertisements providing system (200) may provide an advertisement to the user apparatus (400).

An advertisement providing form of the sure apparatus (400) does not fundamentally influence an embodiment of a method for providing advertisements in accordance with the present invention. Various forms of a method for providing advertisements such as a search keyword advertisement through matching a search keyword with a keyword specified for advertiser, a context advertisement provided with offering contents, and a banner advertisement to which local targeting information is applied may be utilized for the embodiment of the present invention. Since description regarding a search keyword advertisement, a context advertisement, and a targeting option for advertising is a self-explanatory matter to a person of ordinary knowledge in the pertinent art, detailed explanation is omitted below.

The advertisements providing system (200) may execute a content service accompanied by providing advertisements, but a separate publishing system, while being concerned with providing of an advertisement in accordance with the embodiment of the present invention, may also attract a user by providing a content service. The publishing system is to be explained in detail hereafter.

The advertisements providing system (200) may provide information regarding a result of advertisement published to the advertiser's apparatus (300).

Regarding providing an advertisement in accordance with the embodiment of the present invention, calculating expanses regarding publishing of an advertisement may be executed by autonomous budget appropriation by the advertiser after the advertisement being published. That is, the advertiser, following advertiser's own judgment, may have a right to present the expense which the advertiser is willing to pay as ‘self-billing’ in matters with the previously published advertisement.

The advertisements providing system (200) may provide information regarding a result of advertisement published in order to aid the advertiser's presentation of self-billing. For example, various indicators such as the display count of advertisement published, the observed click count (OCC), the click count per hour, and the click count per section providing advertisement may be presented as auxiliary information for self-billing appropriation of advertiser.

Also, the advertisements providing system (200) may provide the interface for estimating the utility click count, that is, click counts determined that they are effective among observed click counts. Through such interface, the advertiser may refer to log information of click unit regarding publishing advertisements, and understand the utility click count with clicks corresponding to a certain condition being excluded (for example, clicks from a specific IP, clicks in certain period of time, clicks repeated periodically).

Based on ‘information regarding a result of advertisements published’ provided by the advertisements providing system (200), the advertiser may determine the expenses that the advertiser needs to pay, and convey the amount of expenses that the advertiser is willing to pay to the advertisements providing system (200) as ‘self-billing information’ upon corresponding advertisement.

The advertiser may input ‘self-billing information’ per unit of the advertisement being published. In the case of publishing of advertisement per keyword, the advertiser may input different ‘self-billing information’ upon publishing of advertisement per each key word unit. Also, in the case of publishing of advertisement per hour, the advertiser may input different ‘self-billing information’ for each of publishing time period.

For example, in a situation in which the advertiser registers an advertisement regarding a keyword such as flower delivery, flower basket, and anniversary, and then provides through the advertisements providing system (200),

Even if the observed click counts from the keyword, flower delivery, and the observed click counts from the keyword, anniversary are the same, the advertiser may pay separately in terms of each of keywords.

Also, the advertiser may input ‘self-billing information’ by designating the time period of advertisement publishing. For example, in a situation where there are many advertisers who are publishing an advertisement regarding the keyword, flower delivery, an advertiser may input ‘self-billing information’ weekly basis and the other may do monthly basis. Thus, the advertisements providing system (200) may grant the higher degree of freedom regarding the period of expense payment by allowing the advertiser to set-up the time period subjected to payment when inputting ‘self-billing information’. It is also possible to force the periodic payment due.

Thus, the autonomous advertisement information that is conveyed from the advertiser's apparatus (300) to the advertisements providing system (200) may include information regarding discriminative information, the amount of self-billing, the time period of advertisement publishing subjected to payment concerning the corresponding advertisement. Information that will be included in autonomous advertisement information may be changed into various forms in accordance with the composition of the advertisements providing system (200). For example, the advertiser may input the total amount of billing of advertisement concerning the advertisement subjected to payment, and also input the amount of billing per click regarding the observed click counts. Also, in the case of the unit price per click being already predetermined, the valid click counts among the observed click counts regarding the advertisement subjected to payment may be input as the autonomous advertisement information.

The advertisements providing system (200) may execute billing regarding the previously published advertisement based on the advertiser's autonomous advertisement information which is input by the advertiser's apparatus (300).

Billing of the existing CPC model based search keyword advertisement is executed based on a bidding price that is input by the advertiser prior to user click information and the advertising display. Such billing of the search keyword advertisement may be executed by keeping account information for the advertiser in a data base and reflecting the total amount of billing that is determined in accordance with the advertising display and users' clicks.

In the method for providing advertisements in accordance with the embodiment of the present invention, the advertisements providing system (200) may also store account information related to the advertiser in the data base and charge the expense for advertisement publishing by altering the account balance of the advertiser after publishing the advertisements. While being different from the billing process in the existing CPC search keyword advertisement, the amount of billing in accordance with the embodiment of the present invention is determined based on ‘self-billing information’, which in input by the advertiser after the advertisement being published.

For example, the advertiser who published the advertisement for 2 months from November with a multiple of keywords upon an identical sale page may be provided with statistical information concerning 2 months. According to the statistical information provided, observed click counts of November is 3000 and that of December is 4000. However, despite the increase in the observed counts, in a situation where sales of November is greater than that of December (in a situation where the replaced keyword only caused an increase in click counts which are irrelevant to sales), the advertiser may administer total of $5,500 as the amount of self-billing for advertisement publishing in November, and total of $4,500 as the amount of self-billing for advertisement publishing in December. In this case, the amount of self-billing is the payment expense for the entire campaign regarding a sale page subjected to advertising, not for a keyword unit. The advertisements providing system (200) reduces $10,000 from the account of advertiser based on the amount of self-billing from the advertiser.

For another example, the advertiser who published a banner advertisement is provided with a number of display of the banner, click counts of the banner by the advertisements providing system (200), in the situation in which the advertiser input $3,000 as the amount of self-billing for a week, the advertisements providing system (200) may execute billing for advertising the banner by reducing $3,000 from the advertiser's account.

As the example, the advertisements providing system (200) entirely trust the autonomous advertisement information from the advertiser and intactly reflect it to the actual billing information. Thus, in the case of executing billing based on the autonomous advertisement information from the advertiser, the uncertainty of the existing CPC based search keyword advertisement (for example, the ratio of invalid or faulty click, or the ambiguity of advertisement quality index criterion that is reflected to the calculation of the amount of billing) may be eliminated.

On the other hand, in publishing an advertisement in unit of keyword, the advertisements providing system (200) may set a limit for the amount of self-billing that the advertiser may autonomously set based on information regarding a result of advertisement published in the past.

For example, the advertisements providing system (200) may calculate the estimated amount of billing based on information regarding a result of advertisement published of the advertiser, and reduce the uncertainty in advertising billing by setting a possible range of self-billing where the estimated amount of billing belongs. The estimated amount of billing may be calculated based on such as the weighted moving average of advertisement publishing budget in the past, and a weighted factor for elapsed time may be considered during the calculation process. The weighted factor may be designed in order to reflect the seasonal pattern or the weekly pattern, or have larger leverage on the recent budget execution.

For another example, finally, the limitation in the form of not allowing a rapid change with the extent greater than a certain scale according to a standard considering the scale of the last executed advertisement budget may be enforced.

In previously described application of limitations regarding setting the autonomous advertisement information, an input of the autonomous advertisement information itself, which deviates from the limiting condition, may not be allowed. Also, it is also possible to manage flexibly with a form of leaving an additional authorizing procedure while allowing an input of the autonomous advertisement information, which deviates from the limiting condition.

The advertisements providing system (200) may adjust the advertisement display attribution in the future based on the autonomous advertisement information of advertiser, which is input from the advertiser's apparatus (300).

For example, a case in which the advertisement is being charged and published in unit of keyword is assumed. The advertisements providing system (200) provides a result of publishing regarding the advertisement of advertiser related to the keyword after the advertising week is over. The advertiser inputs the amount of billing, which the advertiser is willing to pay, regarding the keyword advertisement during the last week of advertising by referring to information regarding a result of publishing advertisements. Base on the amount input by the advertiser, the total amount of billing (may be adjusted through the exception processing) reduces the balance of the accounts. In a situation where the advertiser still wants to keep publishing the advertisement having the same keyword, the priority index may be adjusted based on the total amount of billing for the last week of publishing the advertisement.

The above mentioned priority index may be expressed as equation 1 and equation 2 as below.

Priority index (RI)=the total amount of billing/expected click counts (ECC) Equation 1

Expected click counts (ECC)=Expected click ration according to the advertisement display embodiment (CCR)×User click counts from the previous advertisement display Equation 2

Here, the click count ratio (CCR) is the ratio of click count.

The priority index by the equation 1 may be understood as an index for estimating a unit price per click expected in the future advertising display, and by arranging with a criterion being the priority index, the amount of billing regarding publishing the advertisement may be maximized in the future.

For example, the priority index may be calculated with a function based on sales expected relative to advertisement published. That is, the priority index that is proportional to the estimated total sales rather then the expected unit price per click may be applied.

Thus, the priority index may be calculated through various indexes related to sales regarding an advertisement that is going to be displayed in the future, and in calculation of estimation index, the weighted factor according to time may be applied to the past advertisement result.

The above priority index is a mere example and various priority indexes may be adopted to optimize the sales expenses in the future according to publishing an advertisement based on the autonomous advertisement information input by an advertiser.

Such priority index may be comprised with indexes regarding the result of advertisement published, and may be calculated without considering the quality index that reflects such as relationship between the advertisement and the advertisement display page. Despite adequacy of the title and description (T&D) of the advertisement, an index regarding the quality of produce service being sold through the advertisement, that is, a quality index may be considered, in order to eliminate the uncertainty of process of calculation of quality index which may be a problem in the relation with the advertiser, the embodiment of the present invention may be embodied with the calculation of priority index in the form of excluding the quality index.

According to one embodiment of the present invention, the advertisements providing system (200), when requested regarding providing the advertisement by the advertiser's apparatus, may receive together with information regarding a plurality of keywords which the advertiser hopes to describe the advertisement. For example, in the case of the advertiser being a business for flower delivery, aforesaid a plurality of keywords may be such that “flower delivery”, “flower basket”, “anniversary”, and “celebration gift”.

In this case, the advertisements providing system (200) may publish advertising information on the sale page in order to display such as the aforesaid advertiser's web page when a user of the user apparatus (400) inputs among the aforesaid keywords. According to the other embodiment of the present invention, a keyword for publishing advertiser's advertisement information considering such as type of business, scale, advertising budget of the advertiser requested may be determined.

The advertisement provided by the advertisements providing system (200) may be provided to the user apparatus (400) through a web page controlled by a separate publisher system (not shown) or a web page controlled by an advertising system.

Such advertisements providing system (200) includes a contents search engine, and may be an administrative server of another search site or an internet portal site that may provide a search result page including advertisement information along with various contents corresponding to a search keyword that is input by a user.

In accordance with the embodiment of the present invention, the advertiser's apparatus (300) may include a digital tool including a function that enables to connect and communicate with the advertisements providing system (200). Such digital tool may be an industrial server, but it may be a personal computer. A desk top computer, a lap top computer, a work station, a PDA, a web pad, a cell phone may be an example of the personal computer. Besides above mentioned, any digital tool having a computational capability with a micro processor and a memory mean may be adopted as a digital tool that comprises the advertiser's apparatus (300) in accordance with the present invention.

Specifically, the advertiser's apparatus (300) may include an application program or a program module that enables the advertiser to input information regarding a condition for providing an advertisement, to select a plurality of keywords for using advertisement providing, to confirm a result of the advertisement published in terms of key words, or to present the amount of self-billing concerning the keyword based on the result of advertisement published that is confirmed. Such application program and program module may be the ones transmitted from the advertisements providing system (200).

On the other hand, the advertiser's apparatus (300) may be replaced with a home page administrative server for an advertiser providing a service or a product.

The user apparatus (400) in accordance with the embodiment of the present invention is a digital tool including a function that enables to connect and communicate with the advertisements providing system (200), and any digital tool having a computational capability with a micro processor and a memory mean such as A desk top computer, a lap top computer, a work station, a PDA, a web pad, a cell phone may be adopted as a digital tool that comprises the user apparatus (400) in accordance with the present invention. Also, the user apparatus (400) may include a web browser (not shown) that enables contents to be offered.

As mentioned above, although not shown in FIG. 1, a separate publishing system may participate in providing an advertisement in accordance with the embodiment of the present invention.

For example, in the case of the user apparatus (400) inputting a query while visiting a certain site, a search result page provided by the user apparatus (400) may be provided with the search advertisement related to the query.

Such search advertisement may be provided in the form of being included in the search result page by the user apparatus (400), but all functions related to the composition of the search result page does not have to be supported by the user apparatus (400).

A system for providing a search result page in terms of the response regarding the query of the user apparatus (400) may be a search engine system composed separately from the advertisements providing system (200). The advertisements providing system (200) may provide the input inquiry from the user apparatus (400) and related advertisement in the form of being included in the search result page.

In the form of providing advertisements explained above, since a search engine system consequently comprises the page for publishing an advertisement, it may be referred as a publishing system.

For another example of a publishing system, a new site providing system and a blog hosting system may provide an advertisement to the user apparatus (400) through the communication with the advertisements providing system (200) in accordance with the embodiment of the present invention.

In this case, the publishing system that provides contents such as new articles or blog postings may requests to provide an advertisement related to the contents through the user apparatus (400).

That is, contents and advertisements that will be provided to the user apparatus (400) may be controlled through a single contents providing page by different systems. In terms of matching between contents and advertisements, technologies related to a keyword advertisement and a context advertisement of publication may be used. Since detailed explanations of matching advertisements are a self-explanatory matter to a person of ordinary knowledge in the pertinent art, detailed explanations are omitted below.

On the other hand, in the situation where such publishing system intervenes the advertisement providing, record information regarding behaviors of users (such as clicking) regarding the advertisement provided may be aggregated and conveyed to the advertisements providing system (200) by the publishing system, and may directly be aggregated by the advertisements providing system (200).

Configuration of an Advertisements Providing System

Hereinafter, an internal configuration as well as functions of each element for an advertisements providing system, which conducts an important role to implement embodiments of the present invention, will be described.

FIG. 2 shows an internal configuration of an advertisements providing system 200 in detail, in accordance with one embodiment of the present invention.

Referring to FIG. 2, the system according to the embodiment of the present invention may be configured to include a unit for providing advertisement 210, a unit for analyzing user operations 220, a unit for analyzing result of advertising 230, a unit for providing information 240, a unit for processing billing 250, a unit for controlling display attribution 255, a database 260, a communication unit 270 and a control unit 280.

According to the embodiment, the unit for providing advertisement 210, the unit for analyzing user operations 220, the unit for analyzing result of advertising 230, the unit for providing information 240, the unit for processing billing 250, the unit for controlling display attribution 255, the database 260, the communication unit 270 and the control unit 280 may be program modules, at least some of which communicate with an advertiser terminal 300 and a user terminal 400.

These program modules may be included in the advertisements providing system 200 as a form of an operating system, an application program and other kinds of program modules, and physically stored at various kinds of known memory devices.

Also, these program modules may be stored at a remote memory device which may communicate with the advertisements providing system 200.

Further, these program modules cover routines, subroutines, programs, objects, components, data structures and so on to either conduct certain operations or execute certain abstract data patterns as described later herein, although not limited thereto.

First, the unit for providing advertisements 210 provides the user terminal 400 with advertisements. That is, when a user using the user terminal 400 inputs a keyword through an operation site operated by the advertisements providing system 200, the unit lets advertisement information corresponding to the keyword be included on a search result page and provides the user with the search result page. At this time, the unit for providing advertisements 210 may refer to the database 260 storing advertisement information of the advertiser matched with each keyword.

Next, the unit for analyzing user operations 220 analyzes behaviors of the user receiving the advertisements through the user terminal 400. In detail, advertisement information related to several advertisers may be provided to the user by inputting a keyword through the operation site operated by the advertisements providing system 200, and the unit for analyzing user operations 220 analyzes operations shown by the user (for example, a user click to advertisement information etc.) at this time.

The analysis of user operations may include processes of recognizing identification information indicating which advertisement information on the search result page was selected by the user [For example, URL (Uniform Resource Locator) information] and storing it. Also, the analysis of user operations may include processes of matching at least some of advertisement information on the search result page selected by the user, identification information of the advertiser corresponding to the advertisement information (For example, a number identifying the advertiser, an URL of the advertiser's web page and so on), and a search keyword corresponding to the search result page with one another and store them.

As described earlier, in case a separate publishing system participates in displaying advertisements to the user, reaction information of the user toward the advertisements is collected by the publishing system and input to the advertisements providing system. Also, in case the advertisements providing system has the authority to control some areas of the page displaying advertisements (in case of the search advertisement, various forms such as the search result providing page and the main page displaying banner advertisements on news websites and so on may be included) provided by the publishing system to the user terminal 400, click information of the user may be directly transmitted to the advertisements providing system 200. The operation (reaction) information of the user is stored at the database 260 as a form of advertisements providing log.

The unit for analyzing result of advertising 230 analyzes results of advertisements published by plural keywords each advertiser selects based on the data related to users' operations, which was collected by the unit for analyzing user operations 220. In other words, the unit for analyzing result of advertising 230 may analyze how much each keyword contributes for displaying advertisements of the advertiser to the users by referring to information stored by the unit for analyzing user operations 220.

For example, if the advertiser runs a business providing a flower delivery service, a number indicating how many times advertisement information of the advertiser provided by inputting a keyword “flower delivery” is selected may be calculated in distinction from a number indicating how many times advertisement information of the advertiser provided by inputting a keyword “flower basket” is selected.

The unit for analyzing result of advertising 230 generates a result indicator related to advertisements publishing to be provided to the advertiser based on log information of advertisements published which is stored at the database 260. Various forms of the result indicator such as a number of clicks for the advertisements, a variation rate according to the time and statistics concerning clicks suspicious of invalid clicks among observed clicks and so on may be stored at the database 260.

The unit for providing information 240 provides information acquired by the unit for analyzing result of advertising 230, that is, information concerning results of advertisements published, with the advertiser terminal 300. In other words, the unit for providing information 240 delivers information concerning the number of selecting advertisements information by keywords which were produced by the unit for analyzing result of advertising 230 to the corresponding advertiser terminal 300. Along with this, the unit for providing information 240 further delivers suggested information of self-billing to the unit for processing billing 250 as will be described later, if the advertiser suggests information of self-billing per each keyword through an advertiser interface, as will be described later. The advertiser may input information of self-billing per advertisement publishing unit, and information of self-billing may include information concerning identification information of the corresponding advertisements, the amount of self-billing and information concerning advertisements publishing period to be billed.

According to the embodiment, the unit for processing billing 250 either requests a billing process by reflecting the amount of the advertiser's self-billing by keywords suggested through the advertiser terminal 300 as it is, or conducts a known billing process using the advertiser's deposit.

According to the other embodiment, the unit for processing billing 250 finalizes the billing process by referring to the amount of self-billing by keywords suggested by the advertiser terminal 300 as appropriate.

For example, if the advertiser suggests too small amount compared to the result of advertisements published as the amount of self-billing, the unit for processing billing 250 may refuse the amount of self-billing and request the advertiser to re-input the appropriate amount of self-billing (For example, if the amount of self-billing less than 50% of the appropriate billing standard as described later is suggested, the amount may be refused.) Also, for another instance, the unit for processing billing 250 compares the amount of self-billing suggested by the advertiser with an estimated billing amount according to the appropriate billing standard for the keyword established beforehand by the advertisements service provider, and determines either the higher amount or the lower amount as the final amount of self-billing necessary for the billing process. Moreover, according to other example, the unit for processing billing 250 determines an average amount between the amount of self-billing suggested by the advertiser and the estimated billing amount according to the appropriate billing standard for the keyword established beforehand by the advertisements service provider as the final amount of self-billing. The estimated billing amount may be calculated based on the result of advertisements published.

As described above, Korean patent application number 2008-66701 of the same applimayt may be referred with respect to how to calculate the so-called appropriate billing standard. It should be regarded that specifications of the patent application above is incorporated into the present invention in its entirety.

According to other embodiment of the present invention, the unit for processing billing 250 receives suggestions of the advertiser's amount of self-billing per each billing period and applies them. With respect to providing advertisement services until the next billing period, the unit may determine the order of display on the advertisements list of advertisements information for advertisers according to the amount of self-billing suggested by each advertiser for the keyword, and display attribution of advertisements including the order of advertisements display may be controlled by the unit for controlling display attribution 255.

On the other hand, according to other embodiment, the unit for processing billing 250 receives suggestions of the advertiser's amount of self-billing per each billing period and applies them, but the unit may instruct the unit for providing advertisements 210 not to display advertisements information of the advertiser suggesting too low amount of self-billing for a certain keyword on the corresponding search result page during providing the advertisements service for a certain period of time.

The unit for controlling display attribution 255 controls display attribution of online advertisements related to the advertiser considering information of self-billing as described. That is, the unit for controlling display attribution 255 calculates a priority index in proportion to the total amount of billing calculated by using the amount of self-billing which was suggested by the advertiser after results of advertisements published, and arranges advertisements that are going to be displayed in the future according to the calculated priority index and provides with them. The priority index may be calculated by the equation 1 and equation 2 as described above, or calculated using various estimation indicators related to sales of advertisements to be displayed in the future.

The priority index calculated by the unit for controlling display attribution 255 and the order of advertisements display based on the priority index etc. is stored at the database 260 and managed, and the priority index and the order of advertisements display may be utilized as an arrangement standard for the advertisements to be published in the future by being referred to the unit for providing advertisement 210.

Also, online advertisements are managed by keywords or campaigns, and identification numbers for their management units are assigned and stored at the database 260. Each element configuring the advertisements providing system 200 may refer to information needed using the identification numbers.

On the other hand, the display attribution of advertisements controlled by the unit for controlling display attribution 255 should not be limited to the priority index which is a standard of the order of advertisement display, the order of display. Attributions of the advertisements display in order to provide information of specific advertisements as a distinguished form as compared to other advertisements with respect to the same keyword, such as attribution of the display information of advertisements itself delivered through the search result page (for example, display fonts, sizes of fonts, color change of background areas etc.), are also controlled by the unit for controlling display attribution 255.

Therefore, the higher is the amount of self-billing suggested by the advertiser, the higher is the priority index so that when the amount of self-billing for a certain advertisement for a keyword is relatively low than the amount of other advertisements for the same keyword, there may be a high possibility that the advertisements deviates the predetermined order of display according to the result of advertisement published.

According to the embodiment, the communication unit 270 transmits information regarding results of advertisements published by keywords analyzed by the advertisements providing system 200 to the advertiser terminal 300, and receives the amount of self-billing or self-billing information suggested by the advertiser through the advertiser terminal 300. In general, the communication unit 270 enables communication of data with the advertisements providing system 200.

The control unit 280 in accordance with one embodiment of the present invention controls data flow among the unit for providing advertisement 210, the unit for analyzing user operations 220, the unit for analyzing result of advertising 230, the unit for providing information 240, the unit for processing billing 250, the unit for controlling display attribution 255, the database 260 and the communication unit 270.

In other words, the control unit 280 controls data flow from outside or among each element in the advertisements providing system 200 so that the unit controls to enable the unit for providing advertisement 210, the unit for analyzing user operations 220, the unit for analyzing result of advertising 230, the unit for providing information 240, the unit for processing billing 250, the unit for controlling display attribution 255, the database 260 and the communication unit 270 to conduct their unique functions.

### Embodiments of the Present Invention

A detailed case that an advertiser receives information related to results of advertisements published by keywords through the advertiser terminal 300, and suggests an amount of self-billing by keywords for the advertiser based on the information will be described hereinafter according to one embodiment of the present invention.

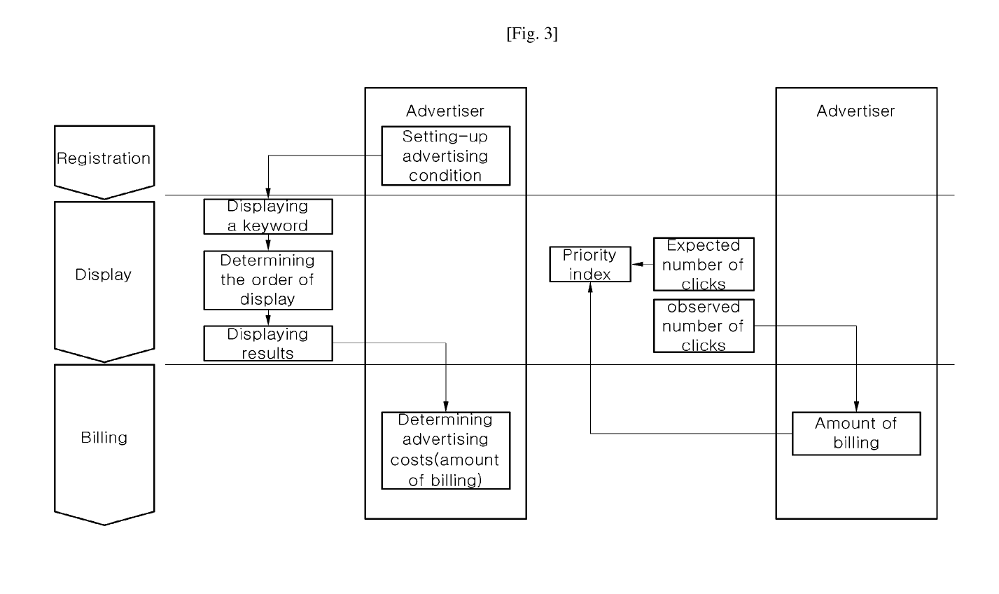

FIG. 3 is a diagram illustrating the way of involvement for entities participating in the method of providing advertisements in accordance with one embodiment of the present invention.

As described above referring to other figures, providing advertisements to the user terminal 400 may be processed with an order of registering advertisements, displaying advertisements and billing the advertisements displayed.

In the registering process of advertisements, advertisers deliver information necessary for displaying advertisements to the advertisements providing system 200. As in typical search keyword advertisements, advertisers register advertisements per each keyword and set up different conditions of displaying advertisements by keywords.

In the displaying process of advertisements, the advertisements providing system 200 determines keywords which the advertisements are displayed about and web pages which the advertisements are displayed through. Also, if several advertisements compete per the same keyword, the advertisements providing system 200 determines the order of display among them. The order of display may be determined using a ranking index (RI) calculated by each advertisement. The ranking index may be calculated based on a number of expected click (ECC) and self-billing information the advertiser inputs for advertisements to be displayed (For one instance, the total amount of cost or the unit price per click toward the keyword advertisement). The advertisements providing system 200 further provides result information of advertisements published (For example, a number of observed clicks) as a basis to evaluate self-billing information input by the advertiser.

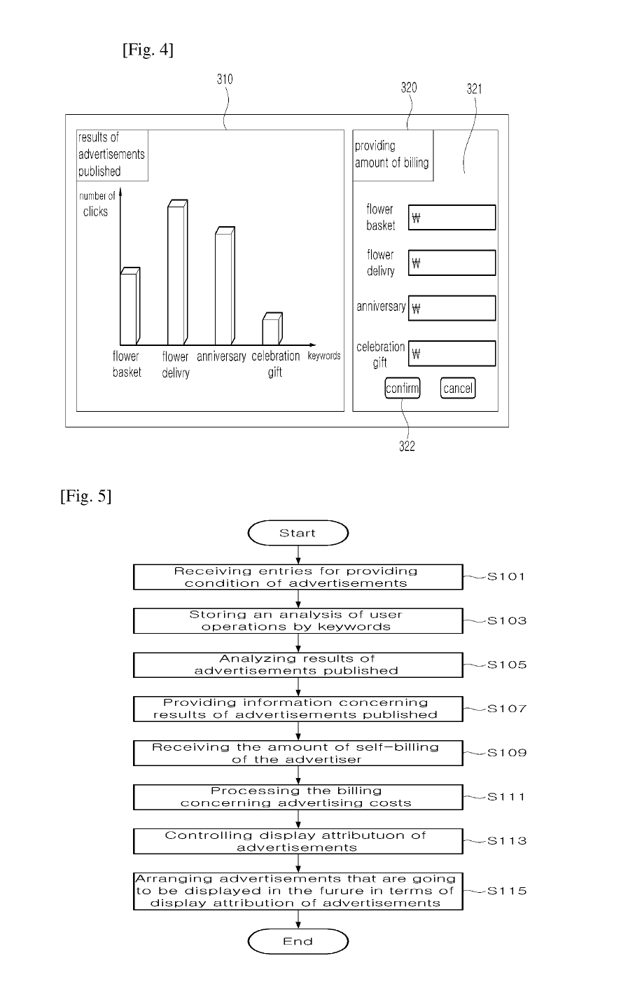

FIG. 4 shows an interface provided to the advertiser through the advertiser terminal 300, in accordance with one embodiment of the present invention. The advertiser terminal 300 includes application programs or program modules displaying information regarding result information of advertising provided from the advertisements providing system 200 as a number of clicks and letting the advertiser suggest the amount of self-billing by keywords, the application programs or program modules may be configured to display the interface of FIG. 4. The interface, however, should not be construed to be displayed by separate programs or program modules, but may be construed to be implemented as a form of a web page provided by the advertisements providing system 200.

The interface in FIG. 4 includes a window displaying results of advertisements published by keywords 310 and a window suggesting the amount of self-billing 320 as illustrated.

A number of user clicks toward the advertiser's advertisement information on a search result page transmitted from the advertisements providing system 200 is displayed by keywords on the window displaying results of advertisements published 310. The number of user clicks by keywords may be displayed as graphs as illustrated in FIG. 4, but this display may be changed by those skilled in the art without limit In other words, various forms including numbers, tables or figures may be included in this display. Information displayed on the window displaying results of advertisements published 310 comprises information collected during a certain period of unit time.

On the other hand, input windows 321 enabling the advertiser to input the amount of self-billing he wants are provided by keywords on the window suggesting the amount of self-billing 320. The advertiser inputs the appropriate amount of billing he thinks based on result information of advertisements published into the input windows 321.

Hereafter, the advertiser transmits information related to the amount of billing he would like to suggest to the advertisements providing system 200 by clicking the confirm button 322 contained on the window suggesting the amount of self-billing 320.

Referring to FIG. 5, a method of providing advertisements by the advertisements providing system having configuration described above will be described as follows.

FIG. 5 is a flowchart to describe the method of providing advertisements by the advertisements providing system in accordance with one embodiment of the present invention.

First, the advertisements providing system 200 receives entries for providing condition of advertisements from the advertiser terminal 300 in order to provide with advertisement services according to the keywords received by the user of the user terminal 400 in S101. In S101, the advertisements providing system 200 receives information related to the plural number of keywords the advertiser wishes to display, or the system determines the plural number of keywords for itself considering information of the advertiser who requested display of advertisements, such as types of business, sizes, a budget for advertisements etc. Besides keywords related to the advertisements, the advertisements providing system 200 receives targeting information for a user whose advertisements are displayed, information related to limits of displaying advertisements, and information related to titles and descriptions of advertisements and so on from the advertiser.

Next, the advertisements providing system 200 stores analysis of user operations such as user clicks followed by inputting a keyword from a user of the user terminal 400 in S103. In S103, analysis of user operations is history information collected during the period of displaying advertisements so that analysis of user operations may comprise processes of recognizing what kinds of operations the user receiving the advertisements does and storing them.

After S103 described above, the system conducts a process of storing analysis of user operations taking place during a designated period of displaying advertisements if the period of displaying advertisements is designated. However, the system may analyze fundamental data related to user operations of previously displayed advertisements if the designated period of displaying advertisements passes over. The period of displaying advertisements may be designated by days, weeks, months or hours, and even by minutes according to need of the advertiser.

Next, the advertisements providing system 200 analyses results of advertisements published indicating how many times advertisements by keywords for the advertiser is displayed to users based on data related to the collected data regarding analysis of user operations in S105.

Next, the advertisements providing system 200 provides the advertiser terminal 300 with information related to the analyzed result of advertisements published in S107. Information related to the analyzed result of advertisements published includes results concerning advertisements that are previously published, that is, various indexes such as displayed number of advertisements published, observed number of clicks, numbers of clicks per by time periods and so on.

Next, the advertisements providing system 200 receives the amount of self-billing input from the advertiser terminal 300 based on the suggested results of advertisements published in S109.

Next, the advertisements providing system 200 either requests a billing process for the total amount of advertisements that are previously published by reflecting the amount of self-billing, or conducts a billing process using the advertiser's account information in S111. In S111, the system may bill advertisement costs by storing the account information related to the advertiser into the database 260 and changing the balance in the advertiser's account after publishing the advertisements.

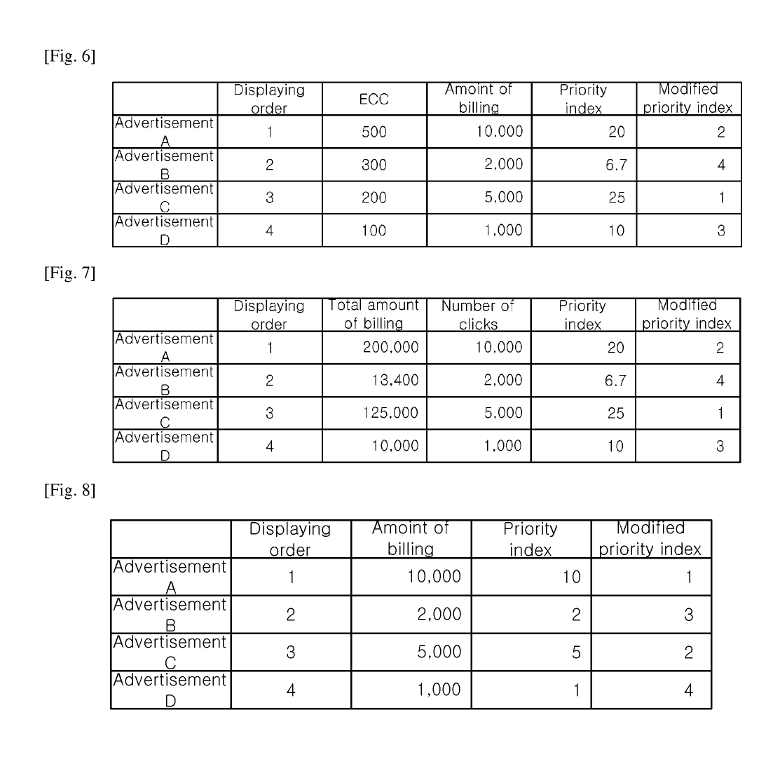

Next, the advertisements providing system 200 controls display attribution of advertisements based on the total amount billed for the advertisements that are previously published in S113. Display attribution of advertisements may includes priority index related to keyword advertisements based on the total amount of costs for the previous advertisements published. Priority index may be calculated in proportion to the total amount billed, calculated by dividing the total amount billed by the number of expected clicks (ECC) as shown in FIG. 6, calculated by dividing the total amount billed by the total number of clicks as shown in FIG. 7, or calculated by dividing the total amount billed by a certain number as shown in FIG. 8.

Next, the advertisements providing system 200 arranges advertisements that are going to be displayed in the future based on calculated priority index in S115. As the advertisements providing system 200 provides with the search result page according to the controlled display attribution, the advertisements may deviates the predetermined order of display if the amount of the advertiser's self-billing is relatively low than the amount of other advertisements. Therefore, it is desirable for the advertiser to suggest the amount of self-billing within the range of appropriate amount of billing.

Although not illustrated by figures, after the step S115 the advertisements providing system 200 may determine if the publishing period of advertisements expires, and conducts processes publishing the advertisements of next publishing period if the period has not expired. If the period expired, the system may be configured to terminate displaying advertisements according to the providing condition of advertisements of the advertiser.

In addition, if a request for changing keywords is transmitted from the advertiser, the advertisements providing system 200 may provide an input window to change keywords, and reflect the changed keywords received through the input window into the advertisement services.

In the present embodiment, the advertisements providing system 200 is configured to provide the advertiser terminal 300 with results of advertisements published for a keyword according to the providing condition of advertisements of the advertiser, but the system may be further configured to provide the advertiser terminal 300 with results of advertisements published for analogous keywords additionally. Therefore, the advertiser may adopt analogous keywords with high number of clicks according to the results of advertisements published for analogous keywords.

The embodiments of the present invention may be realized in the form of program instructions which may be implemented through various computer components, and may be recorded in a computer-readable storage medium. The computer-readable storage medium may include a program instruction, a data file, a data structure, and the like either alone or in combination thereof. The program instruction recorded in the computer-readable storage medium may be any program instruction particularly designed and structured for the present invention or known to those skilled in the field of computer software. Examples of the computer-readable storage medium include magnetic recording media such as hard disks, to floppy disks and magnetic tapes, optical data storage media such as CD-ROMs or DVD-ROMs, magneto-optical media such as floptical disks, and hardware devices, such as read-only memory (ROM), random-access memory (RAM), and flash memory, which are particularly structured to store and implement the program instruction. Examples of the program instruction include not only a mechanical language code formatted by a compiler but also a high level language code which may be implemented by a computer using an interpreter. The hardware devices may be configured to be operated by one or more software modules or vice versa to conduct the processes according to the present invention.

The various embodiments described above may be combined to provide further embodiments. All patents, patent application publications, patent applications, and non-patent publications referred to in this specification and/or listed in the Application Data Sheet are incorporated herein by reference, in their entirety. Aspects of the embodiments may be modified, if necessary, to employ concepts of the various patents, applications and publications to provide yet further embodiments.

These and other changes may be made to the embodiments in light of the above-detailed description. In general, in the following claims, the terms used should not be construed as limiting the claims to the specific embodiments disclosed in the specification and the claims, but should be construed as including all possible embodiments along with the full scope of equivalents to which such claims are entitled. Accordingly, the claims are not limited by the disclosure.

1. An advertisement providing method, comprising:
providing result information of online advertisement published to an advertiser;
receiving self-billing information regarding the online advertisement previously published based on the result information of online advertisement published; and
conducting billing on previously published advertisement based on the self-billing information.

2. The method of claim 1, further comprising:
after the step of conducting billing,
controlling advertising display attribution of an online advertisement related to the advertiser by considering the self-billing information.

3. The method of claim 1, wherein the advertisement comprises a keyword advertisement through matching a keyword and a keyword specified by the advertiser.

4. The method of claim 1, wherein the self-billing information is input in terms of units of which the advertisement is published.

5. The method of claim 1, wherein the self-billing information comprises information regarding identification information, amount of self-billing, and information regarding a publication period of advertisement subjected to payment.

6. The method of claim 1, wherein the conduct of bill further comprising:
calculating a billing estimates based on the result information of the online advertisement published;
setting up a possible range for billing to which the calculated billing estimates belong; and
performing an extra authorizing procedure when the amount of self-billing input by the advertiser does not belong to the possible range for billing.

7. The method of claim 2, wherein the control of advertising display attribution further comprises controlling a priority index regarding a keyword advertisement based on a total amount of billing regarding the result information of online advertisement published.

8. The method of claim 7, wherein the priority index is a value calculated by dividing the total amount of billing by an expected number of clicks (ECC), and the expected number of clicks (ECC) is a value calculated by a multiplication of an expected click expenses (CCR) in accordance with advertising display modes and a number of clicks of a user regarding an advertisement occurred in previous displays.

9. The method of claim 1, wherein the result information of online advertisement is collected by a clicking behavior on a search result page performed by a number of users.

10. The method of claim 1, wherein the conduct of billing further comprises conducting billing regarding advertisement publishing expenses by intactly reflecting the amount of self-billing input by the advertiser.

11. The method of claim 1, wherein the conduct of billing further comprises conducting billing regarding advertisement publishing expenses by changing balance information of an account of the advertiser.

12. The method of claim 1, wherein receiving the self-billing information further comprises receiving the amount of self-billing again by the advertiser if the amount of self-billing suggested by at least some of the plurality of keywords is less than an estimated amount of billing based on pre-determined appropriate billing standard.

13. The method of claim 2, further comprising:
arranging advertisements by the advertising display attribution being a standard.

14. An advertisement providing system, comprising:
a unit for providing information which provides result information of online advertisement published to an advertiser; and
a unit for processing billing which receives self-billing information regarding the online advertisement previously published based on the result information of online advertisement published and conducts billing on previously published advertisement based on the self-billing information.

15. The system of claim 14, further comprising:
a unit for controlling display attribution which controls advertising display attribution of an online advertisement related to the advertiser by considering the self-billing information.

16. The system of claim 14, wherein the advertisement comprises a keyword advertisement through matching a keyword and a keyword specified by the advertiser.

17. The system of claim 14, wherein the self-billing information is input in terms of units of which the advertisement is published.

18. The system of claim 14, wherein the self-billing information comprises information regarding identification information, amount of self-billing, and information regarding a publication period of advertisement subjected to payment.

19. The system of claim 14, wherein the unit for processing billing further sets up a possible range for billing to which a billing estimates calculated based on the result information of the online advertisement published belong, and performs an extra authorizing procedure when the amount of self-billing input by the advertiser does not belong to the possible range for billing.

20. The system of claim 15, wherein the unit for controlling display attribution further controls a priority index regarding a keyword advertisement based on a total amount of billing regarding the result information of online advertisement published.

21. The system of claim 20, wherein the priority index is a value calculated by dividing the total amount of billing by an expected number of clicks (ECC), and the expected number of clicks (ECC) is a value calculated by a multiplication of an expected click expenses (CCR) in accordance with advertising display modes and a number of clicks of a user regarding an advertisement occurred in previous displays.

22. The system of claim 14, wherein the result information of online advertisement is collected by a clicking behavior on a search result page performed by a number of users.

23. The system of claim 14, wherein the unit for processing billing further conducts billing regarding advertisement publishing expenses by intactly reflecting the amount of self-billing input by the advertiser.

24. The system of claim 14, wherein the unit for processing billing further conducts billing regarding advertisement publishing expenses by changing balance information of an account of the advertiser.

25. The system of claim 14, wherein the unit for processing billing further receives the amount of self-billing again by the advertiser if the amount of self-billing suggested by at least some of the plurality of keywords is less than an estimated amount of billing based on pre-determined appropriate billing standard.

26. The system of claim 15, wherein the unit for controlling display attribution further arranges advertisements by the advertising display attribution being a standard.

27. A non-transitory computer-readable storage medium comprising an executable program, which when executed, performs methods according to any of claim 1 to claim 13.
